(19) United States
(12) Patent Application Publication
(10) Pub. No.: US 2014/0012468 A1
(43) Pub. Date: Jan. 9, 2014

(54) Real-Time Center-of-Gravity Height Estimation

(71) Applicants: Jialiang Le, Canton, MI (US); Todd N. Clark, Dearborn, MI (US); Matt Niesluchowski, Clarkston, MI (US)

(72) Inventors: Jialiang Le, Canton, MI (US); Todd N. Clark, Dearborn, MI (US); Matt Niesluchowski, Clarkston, MI (US)

(73) Assignee: FORD GLOBAL TECHNOLOGIES, LLC, Dearborn, MI (US)

(21) Appl. No.: 13/544,171

(22) Filed: Jul. 9, 2012

(51) Int. Cl. G06F 11/30; B60G 17/016; G06F 19/00

(52) U.S. Cl. 701/38; 701/34.4; 701/45

(57) ABSTRACT

A method and apparatus for estimating a center-of-gravity height h of a motor vehicle while the vehicle is in motion. A controller is operatively coupled with a left wheel load sensor, a right wheel load sensor, a lateral acceleration sensor, and a roll rate sensor. The controller determines a left wheel load F_{L} based upon input from the left wheel load sensor, determines a right wheel load F_{R} based upon input from the right wheel sensor, determines a lateral acceleration a_{y} of a vehicle body based upon input from the lateral acceleration sensor, determines a body roll angle φ based upon input from the roll rate sensor, and estimate a center-of-gravity height h in real-time using the calculated values of F_{L}, F_{R}, a_{y}, and φ.

### TECHNICAL FIELD

The invention relates to rollover sensing algorithms and systems for motor vehicles and to a method of estimating a center-of-gravity height for a vehicle for use in such an algorithm and/or system.

### BACKGROUND

Rollover sensing is an important part of overall vehicle safety. Among the safety-related systems that may interface with a roll/rollover sensing algorithm are occupant restraints (seatbelt tensioners/pre-tensioners, inflatable side curtains) and dynamic stability control systems. For example, U.S. Pat. No. 7,130,735 teaches a dynamic stability control system in which a controller determines a roll angle estimate in response to lateral acceleration, roll rate, vehicle speed, and yaw rate. The controller applies the vehicle brakes as necessary to change a tire force vector in response to the relative roll angle estimate, thereby decreasing the likelihood that the vehicle will experience a rollover.

The height above the road surface of a vehicle's center-of-gravity (CG) is an important parameter for most rollover sensing algorithms. Because the actual CG height of a vehicle is difficult to measure or estimate accurately, most existing rollover sensing algorithms assume a fixed, predefined value of CG height which may be based upon an assumed vehicle loading condition under normal vehicle operating conditions.

Using a predefined value for CG height generally performs adequately when applied to passenger vehicles (such as sedans, coupes, and station wagons) because the CG height usually does not change significantly when such vehicles are loaded. The CG height may increase significantly, however, if heavy items are loaded onto the roof of a passenger vehicle.

Vehicles such as trucks, pickup trucks, vans, and large utility vehicle may experience relatively large changes in CG height when they transition between unloaded, lightly loaded, and heavily loaded conditions.

### SUMMARY

In an embodiment disclosed herein, a method of estimating a center-of-gravity height h of a motor vehicle comprises determining a left wheel load F_{L} using a sensor associated with a left wheel, determining a right wheel load F_{R} using a sensor associated with a right wheel, measuring a lateral acceleration a_{y} experienced by a body of the vehicle using a body dynamics sensor, and measuring a roll angle φ using the body dynamics sensor. A controller receives using the values of F_{L}, F_{R}, a_{y}, and φ and estimates the center-of-gravity height h in real-time while the vehicle is in motion.

In a further disclosed embodiment, the controller estimates the center-of-gravity height h as:

$$h = \frac{T \cdot ( {F}_{R} - {F}_{L} )}{2 \cdot m \cdot ( {a}_{y} + g \cdot ϕ )} ;$$

where:

g is a gravitational force acting on the vehicle;

m is a total mass of the vehicle; and

T is a track width of the vehicle.

In a further disclosed embodiment, apparatus for estimating a center-of-gravity height h of a motor vehicle comprises a controller operatively coupled with a left wheel load sensor, a right wheel load sensor, a lateral acceleration sensor, and a roll rate sensor. The controller is configured to determine a left wheel load F_{L} based upon input from the left wheel load sensor, determine a right wheel load F_{R} based upon input from the right wheel sensor, determine a lateral acceleration a_{y} of a vehicle body based upon input from the lateral acceleration sensor, determine a body roll angle ö based upon input from the roll rate sensor, and estimate a center-of-gravity height h in real-time using the calculated values of F_{L}, F_{R}, a_{y}, and ö.

In a further disclosed embodiment, the controller is further configured to identify a rollover condition based at least in part on the estimated center-of-gravity height h.

In a further disclosed embodiment, an occupant safety system is activated in response to the rollover condition.

In a further disclosed embodiment, a dynamic stability system is activated in response to the rollover condition.

### BRIEF DESCRIPTION OF THE DRAWINGS

Embodiments of the present invention described herein are recited with particularity in the appended claims. However, other features will become more apparent, and the embodiments may be best understood by referring to the following detailed description in conjunction with the accompanying drawings, in which:

FIG. 1 is a simplified free-body diagram of a vehicle showing static body roll conditions;

FIG. 2 is a simplified free-body diagram of a vehicle showing dynamic body roll conditions;

FIG. 3 is graph showing steering wheel angle input to a computer model of a vehicle used in a simulation;

FIG. 4 is a plot of results of several runs of a computer model simulation using a CG height estimation algorithm as disclosed herein;

FIG. 5 is a schematic block diagram of a rollover sensing algorithm using a CG height estimation algorithm as disclosed herein; and

FIG. 6 is a system block diagram of a vehicle roll stability control system using a CG height estimation algorithm as disclosed herein.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

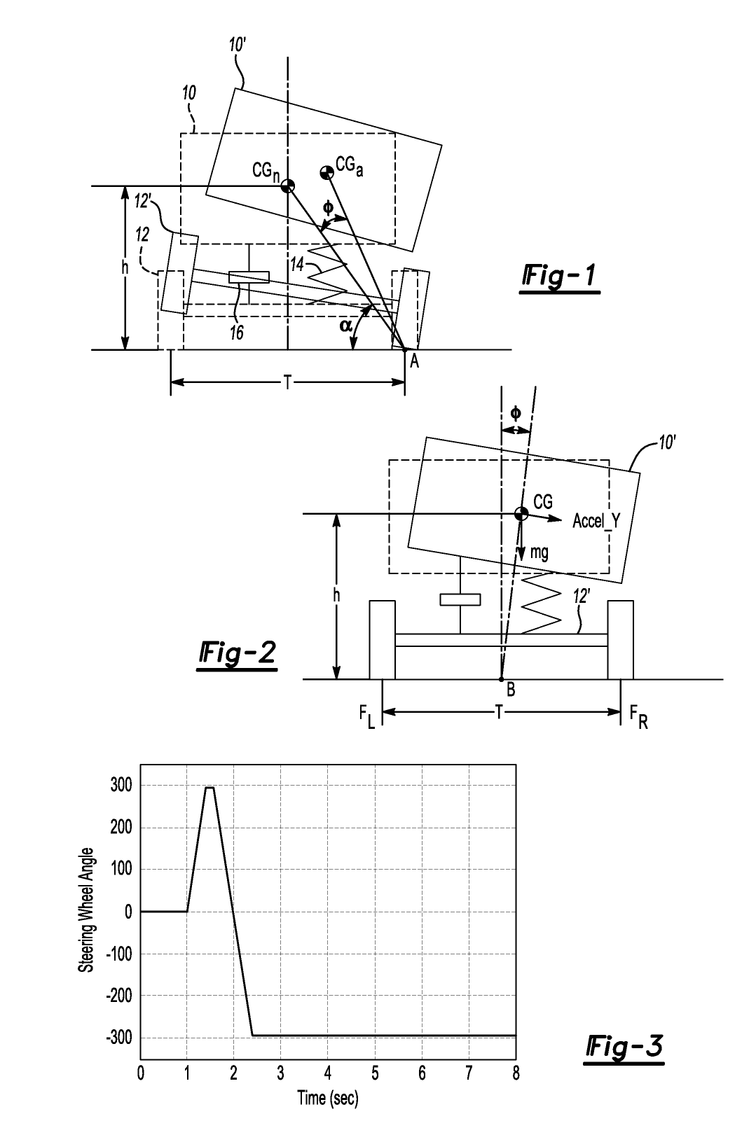

FIG. 1 is a simplified free-body diagram of a vehicle as viewed along the longitudinal axis (x-axis) and includes only one axle (which may the forward or rear axle) and left/right set of wheels.

The dashed lines indicate the vehicle body 10 and axle/wheels combination 12 in an un-accelerated or neutral position, such as when stationary or travelling straight ahead on a level surface. A vehicle suspension is schematically indicated by spring 14 and a damper 16. The CG in the neutral condition is denoted by CG. The angle between the road surface and CGₙ measured about the tire contact point A is the static angle α. Assuming a horizontal road surface,

$$α = arctan ( \frac{2 h}{T} ) \qquad [ 1 ]$$

where,
T: track width
h: height of the vehicle center of-gravity above the roadway surface

The solid lines show the vehicle body 10′ and axle/wheels combination 12′ when subjected to a lateral acceleration such as may occur when the vehicle is turning abruptly (to the left as illustrated) and/or is in a “wheel trip” condition. The CG in this condition is denoted by CGₐ. CGₐ moves relative to CGₐ due to “body roll” (movement of the vehicle body relative to the un-sprung portion of the vehicle as permitted by the suspension) and/or wheel lift. Body roll angle φ is the angle through which the CG moves between the neutral condition and the accelerated condition.

The static stability of the vehicle depends upon the static angle α and the roll angle φ. A static rollover threshold angle λ may be defined as,

λ=90−α+Δ [2]

where Δ is an adjustment angle for calibration purpose, and may be selected based on testing and/or modeling of a specific vehicle design.

If φ exceeds λ, a vehicle rollover may be considered imminent and appropriate safety systems may be activated (deployment of rollover restraint devices, for example) or otherwise altered in response to the condition for a static rollover threshold.

Turning now to an analysis of dynamic stability, a roll rate threshold may be found from the Rotational Energy Principle as,

$$\frac{1}{2} {I}_{A} {ω}^{2} = mgL ( 1 - sin ( α + φ ) ) \qquad [ 3 ]$$

where,
m: mass
g: gravity
I_{A}: polar moment of inertia
L: distance between A and CG
ω: angular (roll) velocity
φ: roll angle
α: static angle

Eqn. 3 may be rewritten as,

$$\begin{matrix}ω = \sqrt{\frac{2 L ( 1 - sin ( α + φ ) ) m g}{{I}_{A}}} \\ where , & [ 4 ] \\ L = \sqrt{{h}^{2} + {( \frac{T}{2} )}^{2}} & [ 5 ]\end{matrix}$$

Pairing of ω angular (roll) velocity and φ roll angle is used for a dynamic rollover threshold. CG height h is one of the important parameters for dynamic rollover algorithm development. As the CG height h increases, the vehicle is more likely to roll over.

FIG. 2 is a simplified free-body diagram of a vehicle, using a “one-mass model” in which the total mass of the vehicle (combined sprung mass and un-sprung mass) is considered to be located at the body center-of-gravity, CG. The vehicle is shown during a turn to the left so that the body 10′ experiences a lateral acceleration a_{y} causing the body to roll to the right. Both the left and right wheels are still on the ground, and an equation of rotation balance around the wheel track center-point B can be written as,

$$m \cdot {a}_{y} \cdot h \cdot cos φ + m \cdot g \cdot h \cdot sin φ + {F}_{L} \cdot \frac{T}{2} - {F}_{R} \cdot \frac{T}{2} = 0 \qquad [ 6 ]$$

where,
m: vehicle mass
a_{y}: y-acceleration at center-of-gravity CG
φ: body roll angle
h: height above road surface of CG
F_{L}: vertical load at left wheels
F_{R}: vertical load at right wheels
T: track width

When φ is small, cos φ≈1 and sin φ≈φ allowing Equation 6 to be simplified as:

$$m \cdot {a}_{y} \cdot h + m \cdot g \cdot h \cdot φ + {F}_{L} \cdot \frac{T}{2} - {F}_{R} \cdot \frac{T}{2} = 0 \qquad [ 7 ]$$

Rearranging Equation 7 yields,

$$\begin{matrix}h = \frac{T \cdot ( {F}_{R} - {F}_{L} )}{2 \cdot m \cdot ( {a}_{y} + g \cdot φ )} \\ where , & [ 8 ] \\ m = \frac{( {F}_{R} + {F}_{L} )}{g} & [ 9 ] \\ when \frac{max ( {F}_{R} , {F}_{L} ) - min ( {F}_{R} , {F}_{L} )}{max ( {F}_{R} , {F}_{L} )} \leq Δ & [ 9 a ]\end{matrix}$$

In equation 9a, max(FR, FL) is the maximum loading measured at any tire/wheel at the time t, and min(FR, FL) is the minimum loading measured at any tire/wheel at the time t. Δ is a calibration value to ensure that all wheels of the vehicle are grounded and bearing a minimum required amount of weight. If the selected value for Δ is exceeded, the algorithm may not give an accurate result.

Equation 8 allows the CG height h to be estimated for any loading condition using values of the required parameters measured by sensors on board the vehicle while it is in motion. a_{y} and φ may be measured by vehicle dynamics sensor (or suite of sensors) of the type well known in the art. F_{L} and F_{R} may be measured by load sensors associated with the vehicle wheels and/or suspension system, or by any other appropriate measurement or estimation technique.

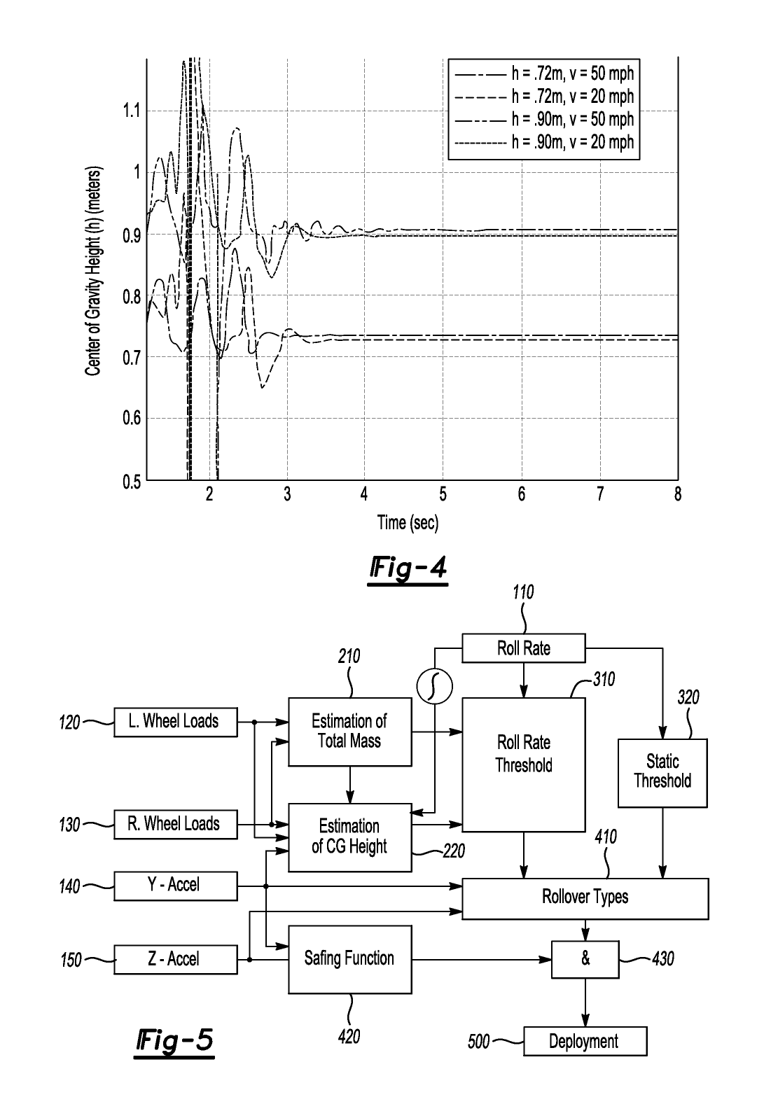

The values required for Equation 8 above may be measured while the vehicle makes an abrupt turn or a “fishhook”-type maneuver generating lateral acceleration at a certain level and duration. FIG. 3 shows the steering input over t=0-8 seconds (expressed as Steering Wheel Angle, in degrees) of a fishhook maneuver that is input to a model of a vehicle used in computer simulation. The wheel forces, roll angle, and y-axis acceleration generated by the model in response to that steering input were used as inputs for the CG height estimation in Equation 8 and the results are plotted in FIG. 4.

FIG. 4 includes plots of four separate “runs” of the simulation. The two upper lines are runs modeling a vehicle with a relatively high CG, one run with the vehicle travelling at 20 miles per hour (mph) prior to beginning the fishhook maneuver and one with the vehicle travelling at 50 mph. The bottom two lines are for a vehicle with a lower CG, again with one run at 20 mph and the other at 50 mph. The plots show that the calculated h is relatively independent of the speed of the vehicle while executing the fish-hook maneuver. The CG height estimations are seen to reach a steady-state condition at approximately t=3 sec.

The CG height h determined in the manner described above may be used in any desired way, such as in a rollover prediction/detection algorithm used to activate a safety system. FIG. 5 is a schematic block diagram of an example of a rollover sensing algorithm. Wheel load signals (120, 130) are used to estimate a total vehicle mass (210) (using, for example, Equation 9 above). Estimation of the vehicle CG height (220) is accomplished (in accordance with Equation 8) using left wheel loads (120), right wheel loads (130), roll angle (110) (which may be integrated from roll rate), y-axis acceleration (140), and estimated total mass (210).

The dynamic threshold, roll rate roll angle, based on rotational energy principle, comparison (310) is accomplished using, for example, Equation 4. The roll angle/static threshold estimation (320) is performed using, for example, Equation 2. Rollover type identification (410) (such as soft trip, hard trip, and ramp-over) may be performed using y-axis acceleration (140) and z-axis acceleration (150) along with the dynamic threshold (310) and static threshold (320) calculations. These threshold values may also be adjusted in real-time based, at least in part, upon the estimated CG height. A method and algorithm for analyzing vehicle roll motion with reference to a static threshold and a dynamic threshold is disclosed in U.S. Pat. No. 7,386,384, the disclosure of which is incorporated herein by reference.

The y-axis and z-axis accelerations may also be used for the safing function calculation (420). Finally, if both the rollover type (410) and safing function (420) requirements are met (430), appropriate safety systems are deployed or activated.

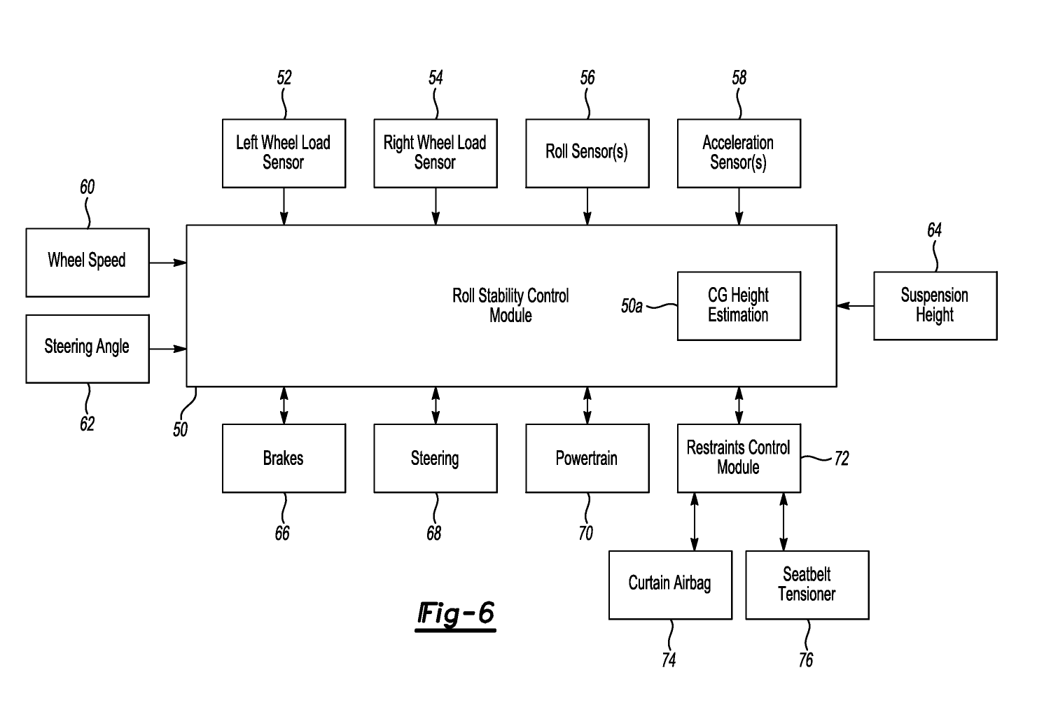

FIG. 6 is a system block diagram of a vehicle roll stability control system of the type that may utilize the dynamic CG height estimation method described herein. A roll stability control module (RSCM) 50 receives inputs from sensors including a left wheel load sensor 52, a right wheel load sensor 54, a roll sensor 56, and an acceleration sensor 58. A CG height estimation portion 50a of RSCM 50 uses the input signals as described above to determine vehicle CG height h while the vehicle is in motion. Other inputs that may be utilized by the RSCM 50 include wheel speed sensors 60, a steering angle sensor 62, and suspension height sensors 64.

RSCM 50 generally operates in a known manner to detect uncommanded or unwanted roll movement of the vehicle. If such movements are detected, RSCM 50 may active one or more of a braking system 66, a steering system 68, and a powertrain system 70 as necessary to prevent or counter the movements. If a rollover condition is detected, RSCM 50 may interface with restraints control module (RCM) 72. RCM 72 may activate occupant protection systems such as a curtain airbag 74 and/or a seatbelt tensioner 76, as is well known in the vehicle safety art.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of estimating a center-of-gravity height h of a motor vehicle comprising:
measuring a left wheel load F_{L} at a time t while the vehicle is in motion;
measuring a right wheel load F_{R} at time t;
measuring a lateral acceleration a_{y} experienced by a vehicle body at time t;
measuring a roll angle φ experienced by the vehicle body at time t; and
solving for the center-of-gravity height h as follows:
$$h = \frac{T \cdot ( {F}_{R} - {F}_{L} )}{2 \cdot m \cdot ( {a}_{y} + g \cdot ϕ )} ;$$
where:
g is a gravitational force acting on the vehicle;
m is a total mass of the vehicle; and
T is a track width of the vehicle.

2. The method of claim 1 wherein the steps of measuring the left and right wheel loads comprise analyzing signals generated by load sensors associated with at least one right wheel of the vehicle and at least one left wheel of the vehicle.

3. The method of claim 1 wherein the lateral acceleration and the roll angle are measured by a vehicle dynamics sensor.

4. A method of estimating a center-of-gravity height h of a motor vehicle comprising:
determining a left wheel load F_{L} using a sensor associated with a left wheel;
determining a right wheel load F_{R} using a sensor associated with a right wheel;
measuring a lateral acceleration a_{y} experienced by a body of the vehicle using a body dynamics sensor;
measuring a roll angle φ using the body dynamics sensor; and
operating a controller to estimate the center-of-gravity height h in real-time using the values of F_{L}, F_{R}, a_{y}, and φ at a time t when the vehicle is in motion.

5. The method of claim 4 wherein the controller estimates the center-of-gravity height h as:
$$h = \frac{T \cdot ( {F}_{R} - {F}_{L} )}{2 \cdot m \cdot ( {a}_{y} + g \cdot ϕ )} ;$$
where:
g is a gravitational force acting on the vehicle;
m is a total mass of the vehicle; and
T is a track width of the vehicle.

6. The method of claim 4 wherein the steps of determining the left and right wheel loadings comprises reading inputs from a left wheel sensor and a right wheel sensor respectively.

7. The method of claim 4 wherein the controller further operates to identify a rollover condition based at least in part on the estimated center-of-gravity height h.

8. The method of claim 7 further comprising the step of activating an occupant safety system in response to the rollover condition.

9. The method of claim 7 further comprising the step of activating a dynamic stability system in response to the rollover condition.

10. Apparatus for estimating a center-of-gravity height h of a motor vehicle comprising:
a controller operatively coupled with a left wheel load sensor, a right wheel load sensor, a lateral acceleration sensor, and a roll rate sensor, the controller configured to:
determine a left wheel load F_{L} based upon input from the left wheel load sensor;
determine a right wheel load F_{R} based upon input from the right wheel sensor;
determine a lateral acceleration a_{y} of a vehicle body based upon input from the lateral acceleration sensor;
determine a body roll angle φ based upon input from the roll rate sensor; and
estimate a center-of-gravity height h in real-time using the values of F_{L}, F_{R}, a_{y}, and φ.

11. The apparatus of claim 10 wherein the controller calculates the center-of-gravity height h as:
$$h = \frac{T \cdot ( {F}_{R} - {F}_{L} )}{2 \cdot m \cdot ( {a}_{y} + g \cdot ϕ )} ;$$
where:
g is a gravitational force acting on the vehicle;
m is a total mass of the vehicle; and
T is a track width of the vehicle.

12. The apparatus of claim 10 wherein the controller identifies a rollover condition based at least in part on the center-of-gravity height h.

13. The apparatus of claim 12 further comprising an occupant safety system activated in response to the rollover condition.

14. The apparatus of claim 12 further comprising a dynamic stability system activated in response to the rollover condition.
